(19) United States
(12) Patent Application Publication
(10) Pub. No.: US 2006/0250210 A1
(43) Pub. Date: Nov. 9, 2006

(54) Modular indicating fuse holder

(76) Inventors: Matthew Thomas Dowil, Washington, MO (US); Matthew R. Darr, Godfrey, IL (US); David Vallier, Clinton Twp., MI (US)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(21) Appl. No.: 11/122,945

(22) Filed: May 5, 2005

(51) Int. Cl. H01H 85/143; H01H 85/165

(52) U.S. Cl. 337/227

(57) ABSTRACT

A modular fuse holder for holding a fuse is provided. The fuse includes an insulative body, conductive terminal elements coupled to the body, and a fuse element extending between the terminal elements within the body. The fuse holder includes a main body defining a fuse-receiving receptacle therein, and the receptacle is configured to substantially enclose the fuse within the main body. The main body includes a line side terminal and a load side terminal positioned in the receptacle, and configured to mechanically and electrically engage the terminal elements of the fuse. The main body includes an outer surface and at least one opening extending therethrough. An indicating assembly is mounted to at least one of the fuse body and the main body, and at least a portion of the indicating assembly is exposed through the opening. The indicating assembly provides visual indication of an operative state of the fuse when the fuse is received in the receptacle.

### BACKGROUND OF THE INVENTION

This invention relates generally to modular fuse holders, and, more particularly, to modular fuse holders adapted for local fuse state indication.

Fuses are widely used as overcurrent protection devices to prevent costly damage to electrical circuits. Fuse terminals typically form an electrical connection between an electrical power source and an electrical component or a combination of components arranged in an electrical circuit. A fusible link is connected between the fuse terminals, so that when electrical current flowing through the fuse exceeds a predetermined limit, the fusible link melts and opens the circuit through the fuse to prevent electrical component damage.

Fuse indicators have been developed for various types of fuses to facilitate identification of inoperable fuses due to an opened fuse link. Fuses including such indicators, sometimes referred to as indicating fuses, typically include a high resistance secondary fuse link and in indicator element extending on or visible through a portion of the outer surface of an insulative fuse body. The secondary fuse link extends between conductive end caps or terminals that are attached to either end of the fuse body, and the secondary fuse link establishes a conductive path in parallel with the primary fuse link. When the primary fuse link operates to open the electrical circuit therethrough, current flows through the secondary fuse link, which causes the indicator element to visibly indicate the operational state of the fuse when an operator or appropriate personnel are in the physical area or proximity of the fuses, sometimes referred to as local fuse state indication. By visually observing the indicating elements of the fuses, and without removing any of the fuses from the system, personnel may quickly identify opened fuses and replace operated fuses to restore circuitry affected by operated or opened fuses. Indicating fuses are commercially available from, for example, Cooper/Bussmann of St. Louis, Mo., and have proven effective when used with open fuse blocks or fuse holders wherein the indicating fuses are visible.

Conventionally, some modular fuse holders enclose one or more fuses in a fuse holder body, and such fuse holders include a slidably or rotatably mounted drawer mechanism to engage fuses to fuse clips in the body of the fuse holder when the drawer is closed, and to pull the fuses from the fuse clips when the drawer is opened. Because the fuses are enclosed in the fuse holder, the body of the fuse is concealed within the fuse holder, requiring that the drawer must be opened and each fuse removed from the fuse holder for inspection, regardless of whether indicating or non-indicating fuses are employed.

### BRIEF DESCRIPTION OF THE INVENTION

In one aspect, a modular fuse holder for holding a fuse is provided. The fuse includes an insulative body, conductive terminal elements coupled to the body, and a fuse element extending between the terminal elements within the body. The fuse holder includes a main body defining a fuse-receiving receptacle therein, and the receptacle is configured to substantially enclose the fuse within the main body. The main body includes a line side terminal and a load side terminal positioned in the receptacle, and the line side and load side terminals are configured to mechanically and electrically engage the terminal elements of the fuse. The main body includes an outer surface and at least one opening extending therethrough. An indicating assembly is mounted to at least one of the fuse body and the main body, and at least a portion of the indicating assembly is exposed through the opening. The indicating assembly provides visual indication of an operative state of the fuse when the fuse is received in the receptacle.

In another aspect, a modular fuse holder includes a main body and a receptacle therein configured to receive a fuse. The main body includes an outer surface substantially enclosing the fuse when located in the receptacle, and the outer surface includes a fuse state aperture extending therethrough. The main body is configured to provide local fuse state indication through the fuse state aperture with each of an indicating fuse and an externally mounted fuse state indicator.

In still another aspect, a fuse state indication system includes a fuse and a modular fuse holder. The fuse includes an insulative body, terminal elements coupled to the body, and a fuse element extending between the terminal elements. The fuse holder includes a main body and a receptacle therein. The main body includes an outer surface substantially enclosing the fuse when located in the receptacle, and the outer surface includes a fuse state indication aperture extending therethrough and exposing a portion of a fuse state indicating assembly, thereby providing local fuse state indication via visual observation of the main body.

### BRIEF DESCRIPTION OF THE DRAWINGS

FIG. 1 is a schematic view of an exemplary fuse.

FIG. 2 is a perspective view of a plurality of exemplary modular fuse holders which may be used with the fuse shown in FIG. 1.

FIG. 3 is a front view of a first embodiment of the fuse holder shown in FIG. 2 with an indicating fuse in the fuse holder.

FIG. 4 is a front view of a second embodiment of the fuse holder shown in FIG. 2.

### DETAILED DESCRIPTION OF THE INVENTION

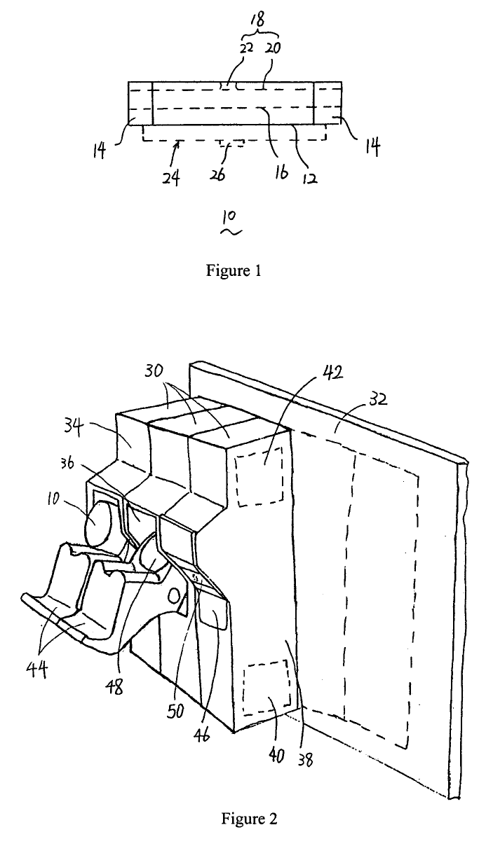

FIG. 1 is a schematic illustration of an exemplary fuse 10 applicable to the present invention. Fuse 10 is a cylindrical cartridge fuse, and includes an insulative (i.e., nonconductive) fuse body 12, two conductive end caps or terminal elements 14 attached to fuse body 12 on either end thereof, and a primary fuse link 16 extending between conductive terminal elements 14.

In an exemplary embodiment, the fuse body 12 is elongated and is generally cylindrical. The terminal elements 14 define a line side terminal element and a load side terminal element on either end of the body 12, and in the illustrated embodiment are generally cap shaped and complementary in shape to fuse body 12. It is appreciated, however, that other shapes and configurations of the fuse body 12 and terminal elements 14 may be provided in alternative embodiments. Therefore, the embodiments of the fuse shown and described herein are for illustrative purposes only, and the invention is not intended to be restricted to a particular fuse type, class, or rating.

A primary fuse link 16 extends between and electrically connects to terminal elements 14, and when terminal elements 14 are connected to line-side and load-side electrical circuitry (not shown), a primary current path is created through primary fuse link 16 between terminal elements 14. Primary fuse link 16 is a known fuse element or assembly, and in an exemplary embodiment includes one or more weak spots or areas of reduced cross sectional area (not shown) therein. Primary fuse link 16 is constructed to withstand only certain electrical currents flowing therethrough. Upon an occurrence of a predetermined magnitude of current corresponding to the current rating of fuse 10, sometimes referred to as an overcurrent condition, the primary fuse link 16 melts, vaporizes, disintegrates, or otherwise fails, thereby breaking the electrical connection through primary fuse link 16.

In an indicating fuse, and as shown in FIG. 1, fuse 10 further includes a known fuse state indicator 18 integrally formed with fuse body 12. Fuse state indicator 18 includes a secondary fuse link 20 extending between and electrically connected to terminal elements 14, and an indicating lens 22 coupled to the body 12 in proximity to the secondary fuse link 20. The secondary fuse link 20 creates a second current path through in parallel with the primary current path of the primary fuse link 16. An indicating element is positioned adjacent the lens and is activated by the secondary fuse link 20 in an overcurrent condition to visually indicate the state of fuse 10 as operable or inoperable. When current flows through the secondary fuse link 20, the indicating element presents a visibly different external appearance of fuse 10 in the vicinity of fuse state indicator 18. Transparent indicating lens 22 is positioned proximate the conductive material of second fuse link 20, and the appearance change, such as a color change that is visible through indicating lens 22, provides local fuse state indication. A variety of indicating elements and mechanisms are known in the art and could be employed in the fuse 10, and the invention is not intended to be restricted to any particular indicating element or mechanism for local fuse state indication.

The secondary fuse link 20 has a much higher electrical resistance than primary fuse link 16, however, so that during normal operation of fuse 10, substantially all of the current passing through the fuse 10 passes through the primary fuse link 16. When the primary fuse link 16 opens and interrupts the current path therethrough, current is diverted into the secondary fuse link 20 until the secondary fuse link 16 also opens to interrupt the current therethrough. As the secondary fuse link opens 16, the indicating element 18 is activated to visibly indicate the opening of the fuse via a physical transformation of the fuse state indicator 18.

In a non-indicating fuse (i.e., a fuse not having the integral indicator 18), and also as illustrated in FIG. 1, a known external fuse state indicator 24 may be employed to nonetheless indicate an operating state of the fuse 10. The fuse state indicator 24 is separately provided from the fuse 10, and is externally coupled to and electrically connected with one or both of terminal elements 14 in use. The fuse state indicator 24 includes an indicating element 26 such as a lamp, and operates in a similar manner to the integral indicator described above. When the primary fuse link 16 opens, externally mounted indicator 24 changes in visual appearance, such as via illumination of lamp 26 to provide local fuse state indication. It is appreciated, however, that a variety of indicating elements for indicting fuses are known and may be employed as externally mounted indicator 24 in lieu of a lamp.

FIG. 2 is a perspective view of a plurality of exemplary modular fuse holders 30 according to the present invention with fuse 10 shown in FIG. 1. Fuse holders 30 are modular, and may be arranged in a side-by-side configuration on a panel 32 to accommodate as many fuses as desired in an electrical system. In an exemplary embodiment, each modular fuse holder 30 receives a single cylindrical cartridge fuse 10 therein, although it is appreciated that each fuse holder 30 may receive more than one fuse 10 in alternative embodiments. It is also appreciated that the fuse holders 30 may also receive non-cylindrical fuses in alternative embodiments, including but not limited to rectangular fuses, in alternative embodiments.

Each fuse holder 30 includes a main body 34 and a receptacle 36 defined in main body 34. Each receptacle 36 is configured to receive a fuse 10 therein, and main body 34 includes an outer surface 38 substantially enclosing fuse 10 located in receptacle 36. Main body 34 further includes a line side terminal 40 (shown in phantom in FIG. 2) and a load side terminal 42 (also shown in phantom in FIG. 2) positioned within each receptacle 36. Line and load side terminals 40, 42 are, for example, known fuse clips configured to engage the terminal elements 14 (FIG. 1) of the fuse 10, although it is appreciated that a variety of terminal elements known in the art may be employed in lieu of fuse clips in alternative embodiments. The line side terminal 40 is connected to a power source or power supply (not shown), and the load side terminal 42 is connected to a power-receiving device or component (not shown) in the electrical system. When the line and load side terminals 40, 42 are mechanically and electrically engaged with conductive terminal elements 14 (shown in FIG. 1) of fuse 10, the fuse 10 provides overcurrent protection for the power-receiving devices in the electrical system and isolates the power-receiving devices from damaging overcurrent events.

In one embodiment, each main body 34 further includes a drawer 44 pivotally mounted thereto. Drawer 44 is pivotable between an open position (shown in FIG. 1) and a closed position described below. The drawer 44 is configured to receive the fuse 10 and to engage line and load side terminals 40, 42 with terminal elements 14 (shown in FIG. 1) of fuse 10 mounted thereon when in the closed position, or alternatively to pull the terminal elements 14 of the fuse 10 from the line and load-side terminals 40, 42 when in the opened position. The drawer 44 further includes a front face 46, a slot 48 for mounting fuse thereon, and a fuse state indication aperture 50 defined on front face 46 and extending through the front face 46 of the drawer 44. The fuse state aperture 50 is in communication with receptacle 36, and is configured to cooperate with either an indicating fuse or a non-indicating fuse having an externally mounted indicator to provide local fuse state indication (described in detail hereinafter).

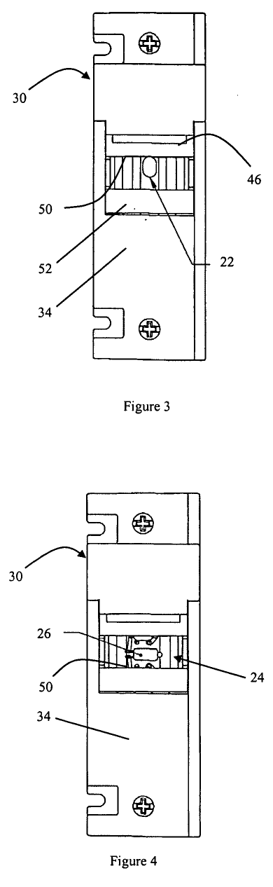

FIG. 3 is a front view of fuse holder 30 shown in FIG. 2 with an indicating fuse in the fuse holder 30 and the drawer 44 in the closed position. A transparent window 52 is attached to front face 46 and covers the fuse state aperture 50. The window 52 blocks dust and contaminants from entering into the interior of the fuse holder 30. The indicating fuse is received in the main body 34, and indicating the lens 22 of the indicating fuse is positioned at a location corresponding to fuse state aperture 50 of the fuse holder 30. Thus, the indicating lens 22 is exposed and visible through fuse state aperture 50, and indicates an operative state of the indicating fuse.

FIG. 4 is a front view of another embodiment of the fuse holder 30 with a non-indicating fuse and an externally mounted indicator 24 in fuse holder 30. Indicator 24 is externally coupled to the non-indicating fuse for providing fuse state indication, and both of indicator 24 and the non-indicating fuse are received in main body 34. The indicating element 26 of the external indicator 24 is then positioned at a location corresponding to fuse state aperture 50. Thus, the indicating element 26 is exposed and visible through fuse state aperture 50, and provides fuse state indication via visual observation of main body 34.

With the fuse state aperture formed in the body of the fuse holder, the modular fuse holder can provide local fuse state indication both with indicating fuses and the non-indicating fuses utilizing the external mounted indicator. Thus, a single fuse holder body including the fuse state aperture allows universal use of the fuse holder with indicating fuses and non-indicating fuses to provide local fuse state identification, and the fuse holder provides a low cost indication system which conventional modular fuse holders cannot accommodate.

While the invention has been described in terms of various specific embodiments, those skilled in the art will recognize that the invention can be practiced with modification within the spirit and scope of the claims.

What is claimed is:

1. A modular fuse holder for holding a fuse therein, the fuse having an insulative body, conductive terminal elements coupled to the body, and a fuse element extending between the terminal elements within the body, said fuse holder comprising:
a main body defining a fuse-receiving receptacle therein which is configured to substantially enclose said fuse within said main body, said main body comprising a line side terminal and a load side terminal positioned in said receptacle, and configured to mechanically and electrically engage the terminal elements of the fuse, said main body having an outer surface and at least one opening extending therethrough; and
an indicating assembly mounted to at least one of said fuse body and said main body, at least a portion of said indicating assembly exposed through said opening, thereby providing visual indication of an operative state of said fuse when said fuse is received in said receptacle.

2. A fuse holder in accordance with claim 1 wherein said main body further comprises a pivotally mounted drawer coupled to said outer surface of said main body, said opening located proximate said drawer.

3. A fuse holder in accordance with claim 1 wherein said indicating assembly includes an indicating element, separately provided from said fuse, that is positioned within said opening, said indicating element changing appearance when the fuse element of the fuse opens and breaks an electrical connection through the fuse.

4. A fuse holder in accordance with claim 1 wherein the fuse includes an indicating lens visible through the insulative body of the fuse, said main body further comprises a pivotally mounted drawer configured to receive the insulative body and engage the line side and load side terminal elements of the fuse to the line side and load side terminals of said main body, the drawer configured to position an indicating lens of the fuse in a location corresponding to said opening, wherein said indicating lens is visible through said opening for local fuse state indication.

5. A fuse holder in accordance with claim 1 wherein said main body further comprises a drawer, said opening extending through said drawer to provide local fuse state indication of the fuse.

6. A fuse holder in accordance with claim 1, wherein said receptacle is configured to receive a cylindrical fuse.

7. A modular fuse holder comprising a main body and a receptacle therein configured to receive a fuse, said main body including an outer surface substantially enclosing said fuse when located in said receptacle, said outer surface comprising a fuse state aperture extending therethrough, said main body configured to provide local fuse state indication through said fuse state aperture with each of an indicating fuse and an externally mounted fuse state indicator.

8. A modular fuse holder in accordance with claim 7 wherein the fuse is an indicating fuse having an indicating lens, said fuse state aperture positioned to correspond with said indicating lens when the fuse is received in the main body.

9. A modular fuse holder in accordance with claim 7 wherein the externally mounted fuse state indicator includes an indicating lamp, said lamp positioned to correspond with said fuse state aperture when the fuse is received in the main body.

10. A modular fuse holder in accordance with claim 7 wherein said receptacle is configured to receive a cylindrical cartridge fuse.

11. A modular fuse holder in accordance with claim 7 wherein said main body further comprises a pivotally mounted drawer configured to receive said fuse.

12. A modular fuse holder in accordance with claim 7 wherein said main body comprises a front face, said fuse state aperture extending through said front face.

13. A modular fuse holder in accordance with claim 11 wherein said fuse state aperture extends through said drawer to provide local fuse state indication of the fuse.

14. A fuse state indication system comprising:
a fuse comprising an insulative body, terminal elements coupled to said body, and a fuse element extending between said terminal elements;
a modular fuse holder comprising a main body and a receptacle therein, said main body including an outer surface substantially enclosing said fuse when located in said receptacle, said outer surface comprising a fuse state indication aperture extending therethrough and exposing a portion of a fuse state indicating assembly, thereby providing local fuse state indication via visual observation of said main body.

15. A fuse state indication system in accordance with claim 14 wherein said fuse state indicating assembly is integral to said fuse, and a portion of said fuse state indicating assembly is visible through said fuse state indication aperture.

16. A fuse state indication system in accordance with claim 14 wherein said fuse state indicating assembly is separately provided from said fuse, and a portion of said fuse state indicating assembly is visible through said fuse state indication aperture.

17. A fuse state indication system in accordance with claim 14 wherein said fuse state indicating assembly includes a lamp.

18. A fuse state indication system in accordance with claim 14 wherein said fuse includes an indicating lens.

19. A fuse state indication system in accordance with claim 14 wherein said fuse is a cylindrical cartridge fuse.

20. A fuse state indication system in accordance with claim 14 wherein said main body further comprises a pivotally mounted drawer configured to receive said fuse.
